(19) United States
(12) Patent Application Publication
(10) Pub. No.: US 2008/0235261 A1
(43) Pub. Date: Sep. 25, 2008

(54) Generating a new file using instance information

(75) Inventors: Alexander Malek, Seattle, WA (US); Shinya Komatsu, Tokyo (JP); Ryosuke Morii, Tokyo (JP)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/726,373

(22) Filed: Mar. 21, 2007

(51) Int. Cl. G06F 17/30; G06F 15/00

(52) U.S. Cl. 707/102; 707/E17.009

(57) ABSTRACT

Embodiments are provided to generate a new file and any appropriate markup for the new file. In an embodiment, the new file and the appropriate markup can be automatically generated based in part on an examination of parameters associated with a source file and an instance of the source file. In one embodiment, a new file associated with a collaboration application can be created, including the appropriate markup, based in part on an examination of objects associated with the collaboration application and an instance of the collaboration application.

### BACKGROUND

Creating customized applications, including web-based applications, can be an extremely technical and laborious process. The difficulty can partially be attributed to inadequate developing tools and rigid coding constructs. For example, the markup of a collaboration application can be arcane, verbose, and complicated. In attempts to improve the customization experience, some software products include editing tools that can be used to customize existing applications. However, the editing tools are typically limited in functionality and applicability, and in some cases, can require a lengthy and unpleasant learning experience. Consequently, users have no choice but to spend countless hours creating and recreating their own tools and customizations.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided to generate a new file and any appropriate markup for the new file. In an embodiment, a new file and the appropriate markup can be automatically generated based in part on an examination of parameters associated with a source file and an instance of the source file. In one embodiment, a new file associated with a collaboration application can be created, including the appropriate markup, based in part on an examination of objects associated with the collaboration application and an instance of the collaboration application.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of a system configured to generate a new file.

FIG. 2 is a flow diagram illustrating the generation of a new file.

FIG. 3 is a flow diagram illustrating the generation of a new file.

FIG. 4 is a block diagram illustrating a computing environment for implementation of various embodiments described herein.

### DETAILED DESCRIPTION

Embodiments are provided to generate a new file and appropriate markup for the new file. In an embodiment, a solution generating application is configured as a software application that includes functionality to evaluate an instance that is associated with a source file. The solution generating application can generate a new file based in part on an assessment of aspects of the instance, such as a number of new or changed objects.

In one embodiment, the solution generating application is configured to compare a number of instance objects with objects associated with a source file. The solution generating application can then generate a new site template, including the appropriate markup, based on the comparison. The solution generating application is configured to synthesize the appropriate markup when creating a new site template. The new site template can be automatically provided for access and use by other users. For example, appropriate markup for a new site template can be automatically synthesized based in part on an introspection of a site instance and a master template.

In another embodiment, a solution generating application can be configured to introspect a set of web site or site objects associated with a site instance. The solution generating application is further configured to automatically synthesize the appropriate markup to represent the set of site objects, including relationships between the site objects. For example, a site can be used to interact on projects, conduct meetings, share information, etc. As described below, users can create or recreate the design, structure, and/or content of a site, including generating new site templates according to a desired implementation.

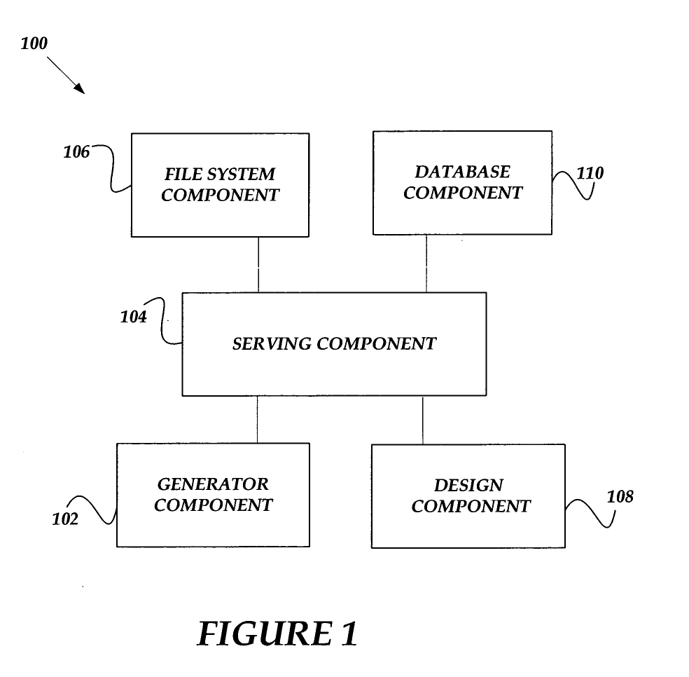

FIG. 1 is a block diagram of a system 100 that is configured to generate a new file, in accordance with an embodiment. For example, the system 100 can operate to generate a new site template based on user customizations and/or preferences, wherein the user customizations and/or preferences can be used to generate the new site template. In one embodiment, the system 100 can be used to create, maintain, modify, and/or present a number of web sites and associated templates.

As described below, the system 100 can use a markup language, such as an extensible markup language (xml) for example, to provide a collaborative environment. Accordingly, the system 100 includes networking, security, and/or other communication functionality to provide a collaborative interactive environment for associated users. The system 100 and its components include functionality to communicate with other computing devices, communication devices, and/or other systems and is not intended to be limited to the embodiments and examples described herein.

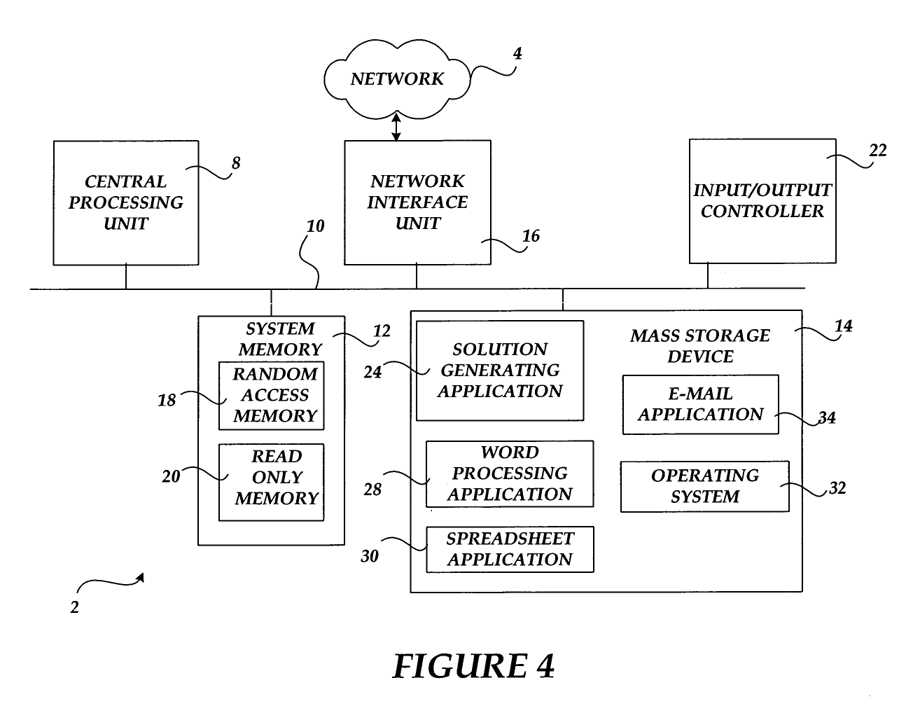

As shown in FIG. 1, the system 100 includes a generator component 102, a serving component 104, a file system component 106, a design component 108, and a database component 110, but is not so limited. The generator component 102 is configured to evaluate a number of parameters (e.g., objects, properties, etc.) and synthesize the appropriate markup while generating a new file, such as a customized web site template for example. As described below, the generator component 102 can compare a base markup with an instance associated with the base markup. Depending on any differences, the generator component 102 can add, remove, and/or edit information when generating a new file. In one embodiment, the generator component 102 can be configured as a software application (see FIG. 4, solution generating application 24) that can generate a new site template based in part on an evaluation of markup parameters of an application instance and a source file.

As described below, the generator component 102 is configured to provide the appropriate markup to represent a set of objects for a new file, including relationships between the objects. For example, the generator component 102 can generate the appropriate markup to create a new site template based in part on an analysis of objects associated with a first site template and objects of a site instance. In an embodiment, the generator component 102 also includes provision handling functionality to ensure that a subsequent file or application created using a new or customized file continues to maintain an association with an original or source file. For example, the generator component 102 can include an event handler for such as purpose.

The provision handling functionality of the generator component 102 can be configured to handle situations involving parameters that are defined in an instance, but not in an associated file, such as a master template for example. For example, a user may customize a cascading style sheet (CSS) behind a site, causing a copy of the master CSS file (e.g., core.css) to be copied into the local site. Since there may not be an associated setting for such an application state, the generator component 102 can be configured to generate unique code for each application to capture the highest fidelity representation of the associated instance. The provision handling functionality can also be used to handle: web site properties; data views in web part zones; data views outside of web part zones; customized CSS files; navigation; workflows; themes; etc.

A file or an application may consist of a number of objects, wherein the objects can be defined according to an object model. An object model can be used in the generation of customized files, such as site templates for example. The object model includes a number of APIs and data structures used by, accepted by, and/or returned by functions associated therewith. Exemplary objects include, but are not limited to: pages; lists; content types; event handlers, document and other libraries; workflows; themes, etc. A file or an application template can include an xml-based representation consisting of a set of xml files representing an application definition (e.g. fields in a list) and a set of manifest xml files representing an associated application structure.

In one embodiment, the file system component 106 is configured to include a number of source files and associated definitions, such as a number of site template files and associated template definitions for example. A source file can include a predefined structure that addresses a particular user need or implementation. In one embodiment, a markup language (e.g., a collaborative application markup language (CAML)) can be used to define aspects of a site template. Each site template can include a set of xml files that represent an application definition and a set of manifest xml files to represent the associated structure.

For example, site templates; can be used to: create a site where users can create, organize, and share information; create a site having a blank home page for customization; create a site for document collaboration; create a site where users can quickly and easily add, edit, and link web pages; create a site where users can post information and allow others to provide comments; create a site to plan, organize, and track meetings; create a blank meeting workspace site for user customization; create a site for reviewing documents and recording decisions made at an associated meeting; create a site to assist in planning and coordinating social occasions; create a site with tools to plan, organize, and track meetings with multiple pages; etc.

With continuing reference to FIG. 1, the serving component 104 can be configured to provide web hosting functionality, document storage functionality, navigation functionality, search functionality, application integration functionality, interactive functionality, personalization functionality, and other collaborative functionality, but is not so limited. For example, the serving component 104 can be configured as a SharePoint® server including the associated functionality. In one embodiment, the serving component 104 can be configured as a web server, and information associated with the file system component 106 and/or database component 110 can be provided by and accessed through a web service infrastructure.

Users can use the design component 108 or other interface (e.g., browser-based editor) and interact with the serving component 104 to customize a file, such as a web site template for example, associated with the file system component 106. For example, a user can use the design component 108 to customize a site template by adding content, deleting content, and/or modifying content associated therewith. In addition to customizing one or more files, other users, such as developers for example, may prefer to create additional files, such as site templates for example, based on a specific need or other requirement.

In one embodiment, changes made to a file are stored through the serving component 104 to the database component 110. For example, the changes can be stored as application instances, web site instances, site instances, etc. An application instance can be described as the instantiation of an application definition, wherein instantiation can be described as a process of generating an instance of an application from an application definition. A data structure or set of data structures can be used to represent an instance of an associated application. In one embodiment, an instance can be defined and created based on one or more web solution definitions. For example, an application instance can be represented as a web-based data structure associated with a database table.

In one embodiment, the serving component 104 uses a difference measure to persist an application instance in the database component 110. The difference measure can be used to represent changes to parameters (e.g., an object, a definition, etc.) associated with an original or source file (e.g., a master site template, another instance, etc.). For example, after customizing a site list, the serving component 104 can operate to store an enumeration of a number of fields based on any differences associated with a master template, wherein the differences can be used to represent a number of fields as compared to the fields of the master template (e.g., removed fields, added fields, changed fields, etc.).

The serving component 104 can operate to store any difference representations to the database component 110. In one embodiment, the difference representations can include a number of pointers or other associations that reference how the changes are associated with an original or source file. Correspondingly, the data storage capability and accessibility of the database component 110 can be maximized by using difference representations.

As another example, after customizing a web page template (e.g. a home page template), the serving component 104 can operate to store the customized page as a new web page template and thereafter direct browsers to the customized web page rather than the original template. Users can also add new content to an associated instance, such as new lists, workflows, pages, etc. The serving component 104 can operate to save the new content to the database component 110 according to a difference representation. Once a user is satisfied with any additions, removals, or changes, a new template can be created and deployed to the file system component 106. Thereafter, the new template can be accessed and used by other users. Correspondingly, other users can use the new or changed template without having to recreate the process previously employed to obtain the new or changed template.

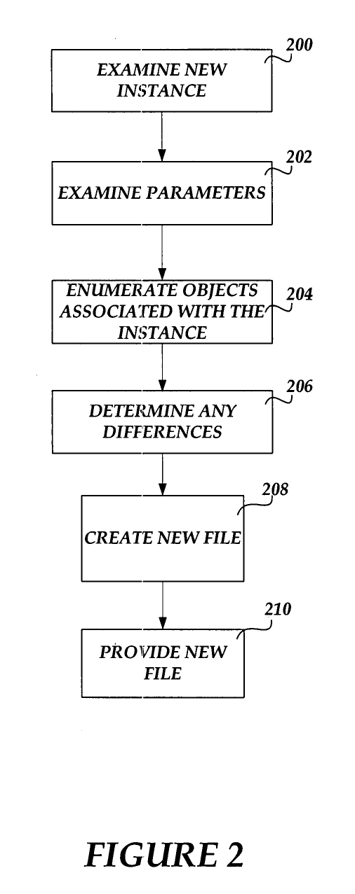

FIG. 2 is a flow diagram illustrating a process for providing a new file, under an embodiment. For example, a new site template can be generated based on a site instance. As described below, the process operates to synthesize new markup based in part on the markup of an associated instance. The components of FIG. 1 are referred to in the description of FIG. 2, but the embodiment is not so limited. At 200, the generator component 102 uses the serving component 104 to examine a new instance as stored on the database component 110. In one embodiment, a web site instance can be used to determine an associated web site template and object model for use in generating a new web site template.

At 202, the generator component 102 can examine parameters of the new instance and/or an associated file or application. For example, the generator component 102 can operate to examine a number of definitions (e.g., markup) associated with a master template as stored on the file system component 106. In one embodiment, the generator component 102 is configured to copy an original site template and the associated definitions, and store the copy locally (e.g., RAM). At 204, the generator component 102 operates to enumerate a set of objects associated with the instance. The generator component 102 has knowledge of the object model associated with the set of objects in the instance.

At 206, the generator component 102 uses the set of objects associated with the instance and the original definition(s) to determine any differences (e.g., additions, deletions, modifications, etc.) as compared to the original file. The generator component 102 can query the serving component 104 to determine which objects are in the original file as stored on the file system component 106. The generator component 102 can also query the serving component 104 to determine the objects associated with the instance as stored on the database component 110, such as any new objects and/or changed objects for example.

At 208, the generator component 102 operates to create a new file that is associated with the instance. In one embodiment, the generator component 102 creates a new site template by merging any determined differences (e.g., new objects, changed objects, etc) into a copy of an original site template. Accordingly, the generator component 102 can create a new site template based on a site instance by providing the appropriate markup for the associated definitions of the original site template and any new or changed definitions of the site instance. At 210, the new file can be stored on the file system component 106 for access and use by other users.

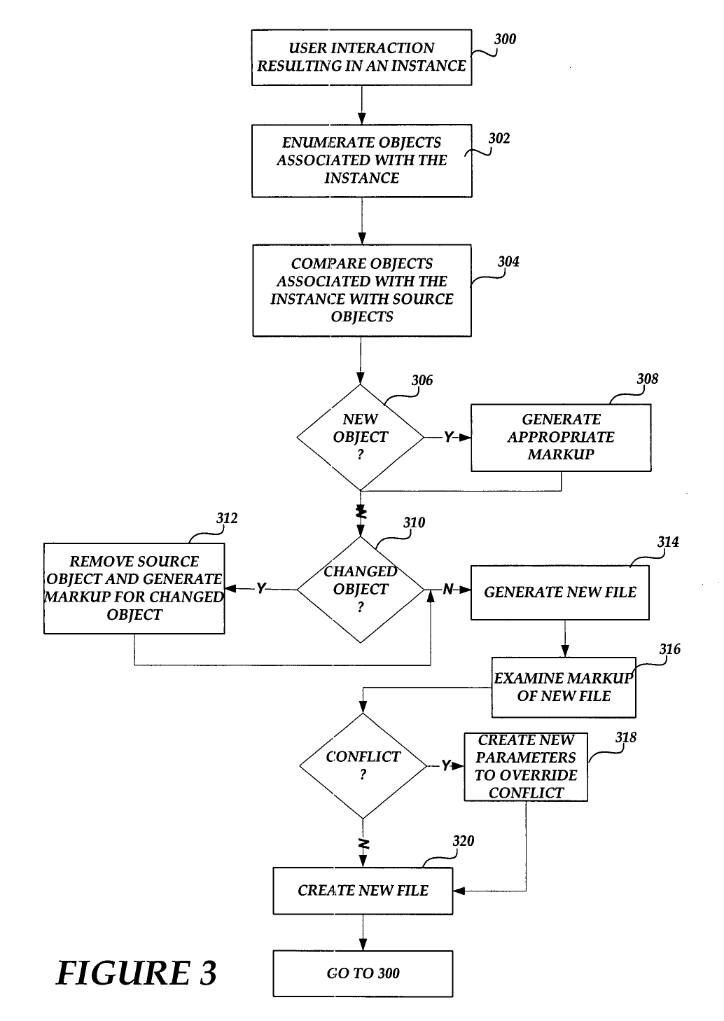

FIG. 3 is a flow diagram illustrating a generation process for generating a new file, under an embodiment. In one embodiment, a new web site template can be generated based in part on an interactive input. A customized template can be generated to include user preferences based in part on a user modification to a source file that results in an instance. As described above, an instance can be created based on changes to a source file or other file, such as an application or a template for example.

At 300, user interaction results in an instance, such as a site instance for example. The instance can be stored and/or accessed for further use. For example, a user may modify a site template, such that the modification affects an object or other aspect associated with a source file. In one embodiment, objects and other aspects associated with a master template can be automatically copied from a file repository after an action that results in a site instance. At 302, an object model can be used to enumerate or tabulate a number of objects associated with the instance. For example, an object model and associated markup can be used to represent a site, lists, pages, documents, document directories, content types, themes, CSS files, workflow, etc.

At 304, objects associated with the instance can be compared to objects of a source file as defined by the associated markup. For example, a difference representing a number of objects associated with a site instance can be compared to a number of objects associated with a master site template. At 306, the results of the comparison can be evaluated to determine if there are any new objects associated with the instance. If a new object is associated with the instance, at 308, the appropriate markup can be generated for each new object and the flow proceeds to 310. In one embodiment, the appropriate markup is generated for each new object by determining how to define each customization associated with the instance.

As described above, certain parameters, such as those associated with new objects for example, may be difficult to define using a markup language. For example, a user can make customizations in a web browser that may not be defined in a master or original template. As further example, a file, such as a CSS file, may be customized in a manner that results in a single site not resembling other sites on a given server. Correspondingly, a site template may not support a particular type of customization in certain cases.

In such a case, a special markup can be used to persist a particular type of customization or other user interaction. In one embodiment, the special markup comprises an xml file including a list of special changes associated with information of a site or instance. The generator component 102 is configured to generate the special markup file for information that may not be properly captured using regular markup. A code handler, such as a C# code handler for example, can be used in conjunction with the special markup. In one embodiment, the code handler can be configured to hard-code and/or provision aspects of an associated instance that are not supported by markup of a master template.

If there are no new objects associated with the instance at 306, the flow proceeds to 310 and, the results of the comparison at 304 can be used to determine if there are any changed objects. If there is a changed object at 310, the flow proceeds to 312 and the original object is removed and appropriate markup is constructed to represent a new version of the object as used in the instance. The flow then proceeds to 314 and a new file, such as a site template for example, can be generated to include the appropriate markup to capture any changed parameters associated with the instance. If there are no changed objects at 310, the flow proceeds to 314 and a new file can be generated that includes the appropriate markup for all objects in the site instance and the original markup for objects that have not changed.

At 316, the markup of the new file can be examined to make sure that there are no conflicts with the original or source file. If there is a conflict, at 318 a number of new parameters can be included in the new file to override the conflict. For example, new internal names, unique ID's, etc. can be included as part of a new site template to override any conflict with a master template. If there are no conflicts, the flow proceeds to 320 and the new file can be created. While FIGS. 2 and 3 are shown to include a certain order, other implementations are available. For example, the determination of a changed object may precede or occur simultaneously with the determination of a new object. In certain embodiments, the processes illustrated in FIGS. 2 and 3 can be implemented as part of the Microsoft® Windows® SharePoint® systems.

The system 100 and its components can be configured to communicate via a wired, wireless, or combination of communication networks. In one embodiment, the generator component 102 is configured to communicate with the serving component 104 using a number of web service application programming interfaces (APIs). For example, the system 100 can be configured as a network software system as part of a distributed computing environment, such as a .NET framework. The system 100 provides a framework that allows developers to create web services and other functionality to execute over a network, such as the Internet for example.

As described above, the serving component 104 is configured to respond to various requests from the generator component 102, but is not so limited. In one embodiment, the generator component 102 can be configured as an add-in software application or as a web browser enabled application. In another embodiment, the generator component 102 can be configured as an add-in to a computer program for assisting developers in creating program code for use in multiple application programs. In yet another embodiment, the generator component 102 can be configured as a graphical user interface (GUI) tool that can be used by an end-user to create customized templates.

Users can also use a web browser or other design component to customize existing applications or templates. For example, a user can create a customized version of a team site, including a designated name and associated user permissions. As described above, differences or deltas associated with customized parameters can be stored in the database component 110 as part of an instance. A customized site template can be created based on the customized version of the team site and an original or source team site, which can be thereafter provided to other users as a new template. The serving component 104 is configured to provide the new template (e.g., based on a URL, etc.) and any associated files, content, and other information associated with the new template. As described herein, the embodiments are configured to examine an application instance and synthesize appropriate markup associated with the instance to represent a customized template, thereby saving developers or other users hours of work.

While the system 100 is shown to include a number of components, it can include fewer or more components according to a desired functionality or implementation. For example, the content associated with the file system component 106 can be combined with the content of the database component 110 and provided to users from a single component. As further example, the generator component 102 can be configured as part of a client application that is a separate component in relation to the system 100. As another example, the functionality associated with the generator component 102 can be included as part of the serving component 104. Moreover, the serving component 104 can include various functionality and other components, such as a front-end functionality, web servicing functionality, metadata managing functionality, markup language functionality, etc. The system 100 can also include multiple clients and is not limited to any particular configuration, wherein each client can include various functionality and other components.

The system 100 can be implemented as part of networked, distributed, or other computer-implemented environment. The system 100 and its components can communicate via a wired, wireless, and/or a combination of communication networks. A number of client computing devices, including desktop computers, laptops, handhelds, or other smart devices can interact with and/or be included as part of the system 100.

As described above, a managed-code object model can be queried for a set of objects that define an instance, such as a site instance. In one embodiment, a site corresponds to an object. The object can be substantiated by passing an associated URL for the site. Additionally, a site can include a number of associated objects. Solution generation logic, included with the generator component 102 or other component, can be used with these and other objects. For example, lists may correspond to list objects, and the list objects may include a number of fields. The fields may include a number of custom properties that define the field attributes, such as Name, Type, Read-only, etc. Site templates can be defined as xml files. For example, lists can be defined using CAML.

As an example, a “Title” field can be defined as:

<Field ID=“{fa564e0f-0c70-4ab9-b863-0177e6ddd247}” Type=“Text” Name=“Title” ShowInNewForm=“FALSE” ShowInFileDlg=“FALSE” DisplayName=“$Resources:core,Title;” Sealed=“TRUE” SourceID=“http://schemas.com/” StaticName=“Title</Field>.

Thus, the solution generation logic can be configured to handle many different types of objects including, but not limited to pages, lists, content types, workflows, CSS files, etc. The solution generation logic can be used to locate pages, lists, content types, workflows, CSS files, etc. associated with a site instance. Thereafter, the logic can be used to serialize or otherwise construct the associated information for a file, such as a site or site template for example. Correspondingly, the logic can be used for each piece of information that defines a site.

The solution generation logic also includes functionality to handle objects without a native serialization. Furthermore, as described herein, the solution generation logic can be used to provide a mapping between a target and a source, since the logic has knowledge of the target XML. That is, solution generation logic includes and uses knowledge of the mapping from instance data to target schema. In the example above, the solution generation logic can use xml schema definitions (XSD) and samples to determine how to construct an object, such as a list field for example. Thus, for each property to be defined as XML, the solution generation logic can rely in part on aspects of the object model and the source when creating a site.

A collaborative system can provide a collection of information sites that are organized to provide centralized, unified, and coordinated access to information associated with the sites. A web browser is one way to interact with such a system. A web browser is configured to interpret web page description files, generate web pages from associated descriptions, display web pages, etc. A collaborative system for supporting the generation of files, such as customized site templates, can includes pages, lists, workflows, documents, document libraries, etc. A list is a web site component that enables a web site user to store and display information using a web browser. A document can be created with an application program to be saved and retrieved on demand. A document library is a collection of documents that can be shared, including any associated metadata. Templates can also be associated with a document library. A web browser can be used to interact with a document library and/or metadata. Workflows can be described as a business or other processes that follow certain rules.

In one embodiment, the system 100 can be configured using Microsoft® Windows® SharePoint® services technology. The Windows® SharePoint® Services technology enables users to create, maintain, and present a collaborative environment to share information. Using the technology, a user can create a web site to provide and share information (e.g., objects on a web server or web folder, etc.) for other users associated with the web site. For example, users can use a number of templates to set-up a web site so that workgroups can share documents, calendars, announcements, postings, etc.

### Exemplary Operating Environment

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 2 comprises a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing an operating system 32, application programs, such as a solution generating application 24, and other program modules. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display, a printer, or other type of output device. Additionally, a touch screen can serve as an input and an output mechanism.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-readable medium including executable instructions which, when executed, manage information by:
interacting with a source file;
creating an instance of the source file, wherein the instance includes a customized parameter;
evaluating the customized parameter including comparing the customized parameter with a source parameter; and,
generating markup for a new file including the customized parameter, wherein the generating of the markup for the new file includes maintaining an association with the source file.

2. The computer-readable medium of claim 1, wherein the instructions, when executed, manage information by synthesizing appropriate markup to represent a set of objects associated with a site template, including relationships between the set of objects.

3. The computer-readable medium of claim 1, wherein the instructions, when executed, manage information by generating markup for a new collaboration application including provisioning the markup for an object defined in the instance but not defined in the source file.

4. The computer-readable medium of claim 1, wherein the instructions, when executed, manage information by determining if a new object or a changed object is associated with the instance and automatically generating the markup for the new object or the changed object.

5. The computer-readable medium of claim 1, wherein the instructions, when executed, manage information by generating a new template including new template markup that includes the markup associated with a source definition and a new template definition.

6. The computer-readable medium of claim 5, wherein the instructions, when executed, manage information by generating the new template including an extensible markup language (xml) definition file and an xml manifest file.

7. The computer-readable medium of claim 1, wherein the instructions, when executed, manage information by generating code to represent a web site property, a data view in a web part zone, a data view outside a web part zone, a customized cascading style sheet (CSS) file, navigation, workflow, or a theme.

8. The computer-readable medium of claim 1, wherein the instructions, when executed, manage information by examining an object associated with an object model to generate a new site template.

9. The computer-readable medium of claim 1, wherein the instructions, when executed, manage information by using a web service to access the customized parameter or source parameter.

10. The computer-readable medium of claim 1, wherein the instructions, when executed, manage information using a difference representation to represent a coded difference between the instance and the source file.

11. The computer-readable medium of claim 1, wherein the instructions, when executed, manage information by copying objects associated with the source file and comparing the copied objects with a number of objects associated with the instance.

12. The computer-readable medium of claim 11, wherein the instructions, when executed, manage information by using a result of the comparison to determine if a new object is associated with the instance, and generating the markup for the new object including using a code handler to provide markup for a new object definition.

13. A system to create a new file comprising:
a design component to design aspects of a new file based in part on a source file, wherein the design component can create a new object and modify a source object;
a generator component to generate markup for a new object or a modified source object including maintaining a relationship between the new object or modified source object and an object model associated with the source file, wherein the generator component is to generate the markup after comparing aspects of the source file with aspects of an instance of the source file; and,
a store component to store the new file for access and use.

14. The system of claim 13, wherein the generator component is further configured to create a new site template by merging any determined differences into a copy of a master site template after comparing the aspects of the source file and the instance.

15. The system of claim 13, wherein the store component includes a number of site templates and associated definitions for use in creating a new web site template.

16. A method of managing information comprising:
receiving an input associated with a customization of a site template, wherein the customization includes customizing an aspect of the site template;
generating a site instance of the site template based in part on the customization;
determining a difference between the site instance and the site template; and
generating code to create, a new site template, wherein generating the code includes generating the appropriate markup for a new object associated with the site instance.

17. The method of claim 16, further comprising generating the appropriate markup for a changed object of the site instance and removing an original object of the site template that is associated with the changed object.

18. The method of claim 16, further comprising using an object model and a code handler to maintain a relationship between aspects of the new site template and the site template.

19. The method of claim 16, further comprising using a special markup to define an undefined customization.

20. The method of claim 16, further comprising determining if there is a conflict between the site template and the new site template and overriding the conflict by modifying the new site template.
